(19) United States
(12) Patent Application Publication
(10) Pub. No.: US 2005/0083997 A1
(43) Pub. Date: Apr. 21, 2005

(54) Multi-user detection in mobile terminal for reducing interference

(76) Inventors: Yonggang Du, Aachen (DE); Dong Wang, Shanghai (CN)

Correspondence Address: PHILIPS INTELLECTUAL PROPERTY & STANDARDS, P.O. BOX 3001, BRIARCLIFF MANOR, NY, 10510, US

(21) Appl. No.: 10/501,419

(22) PCT Filed: Dec. 9, 2002
(86) PCT No.: PCT/IB02/05249

(30) Foreign Application Priority Data
Jan. 17, 2002 (EP) 02075199.6

(51) Int. Cl. H04B 1/707

(52) U.S. Cl. 375/144

(57) ABSTRACT

Interference cancellation in a mobile terminal (4) in telecommunication systems like Direct Sequence-Code Division Multiple Access systems or DS-CDMA systems can be improved by providing the mobile terminal (4) with a multi-user detector (41,42,43). These multi-user detectors require the spreading codes of other mobile terminals (2,3,5,6,7,8,9), which spreading codes are available in base stations (1) and thus need to be sent to said mobile terminal (4). By further transmitting power information of other mobile terminals (2,3,5,6,7,8,9) to the mobile terminal (4), a selector (52) can make an intelligent selection in said mobile terminal (4) and select the most important spreading codes thereby reducing the computational complexity. By locating a selector (22) in a base station (1), an intelligent selection can also be made in said base station. Preferably a selection is made per antenna sector and/or in dependence of antenna sectors, in which case direction information of other mobile terminals (2,3,5,6,7,8,9) need to be used.

The invention relates to a telecommunication system comprising a base station and mobile terminals, with said base station comprising a generator for generating spreading codes and with at least one mobile terminal comprising an interference canceller for reducing interference.

The invention also relates to a base station for use in a telecommunication system comprising said base station and mobile terminals, with said base station comprising a generator for generating spreading codes and with at least one mobile terminal comprising an interference canceller for reducing interference, and to a mobile terminal for use in a telecommunication system comprising a base station and mobile terminals, with said base station comprising a generator for generating spreading codes and with said mobile terminal comprising an interference canceller for reducing interference, and to a method for reducing interference in a mobile terminal, which method comprises the step of generating spreading codes in a base station, and to a processor program product to be run via a base station's processor for use in a base station of a telecommunication system comprising said base station and mobile terminals, with said processor program product comprising a generating function for generating spreading codes in said base station, and with at least one mobile terminal comprising an interference canceller for reducing interference, and to a processor program product to be run via a mobile terminal's processor for use in a mobile terminal of a telecommunication system comprising a base station and mobile terminals, with said base station comprising a generator for generating spreading codes, and with said processor program product comprising an interference cancelling function for reducing interference.

Such a telecommunication system is for example a Direct Sequence-Code Division Multiple Access system or DS-CDMA system.

A prior art telecommunication system is known from U.S. Pat. No. 6,222,833 B1, which discloses a base station comprising a generator for generating spreading codes. This generator is coupled to a multi-user detector having a correlation system with matched filters for despreading a received signal (by correlating the received signal with the spreading codes) and providing samples per multi-user, a reductor coupled to said correlation system for reducing Multiple Access Interference or MAI in these samples, and a decision taker coupled to said reductor for recovering the multi-user messages. A prior art mobile terminal comprises an interference canceller for reducing Multiple Access Interference or MAI decentralizedly, which can be categorized in data aided detectors and non-data aided detectors. Data aided detectors adaptively learn the structure of the MAI, and non-data aided detectors treat MAI as a random process of which the statistics are to be estimated.

The known telecommunication system is disadvantageous, inter alia, due to the interference cancellation in the mobile terminal being insufficient as a result of said adaptively learning (being a slow converging process) and/or said estimating (being an inaccurate process).

It is an object of the invention, inter alia, of providing a telecommunication system as defined in the preamble in which the interference cancellation in the mobile terminal is improved.

The telecommunication system according to the invention is characterized in that said base station comprises a transmitter coupled to said generator for transmitting information comprising at least parts of other mobile terminals' spreading codes to said at least one mobile terminal, which comprises a receiver for receiving said information, with said interference canceller comprising a multi-user detector coupled to said receiver for reducing interference by using said information.

By providing said at least one mobile terminal with the multi-user detector, which needs information comprising spreading codes of other mobile terminals, to be able to reduce Multiple Access Interference or MAI much more than general (decentralized) interference cancellers, the interference cancellation in the mobile terminal is improved much. Due to said mobile terminal now requiring said information, the base station, which already has got this information for its own purposes, is to be provided with the transmitter for transmitting this information to the mobile terminal, which therefore is to be provided with the receiver for receiving this information. The base station thereby uses either a common control channel for broadcasting this information to several or all mobile terminals, or a terminal specific control channel for sending this information to one mobile terminal, or a data channel for sending this information to one mobile terminal.

The invention is based upon an insight, inter alia, that multi-user detectors are better interference cancellers than general (decentralized) interference cancellers, and is based upon a basic idea, inter alia, that the information necessary for a multi-user detector in a mobile terminal can be transmitted from the base station to the mobile terminal.

The invention solves the problem, inter alia, of providing a telecommunication system as defined in the preamble in which the interference cancellation in the mobile terminal as well as the capacity of the telecommunication system are improved.

A first embodiment of the telecommunication system according to the invention as defined in claim 2 is advantageous in that said selector coupled to said receiver in said mobile terminal, by selecting a part of said information to be used by said multi-user detector in said mobile terminal, reduces the computational complexity in the mobile terminal. The selector makes an intelligent selection by using the power information (like power levels) of other mobile terminals, for example by comparing this power information with a threshold and in response to a comparison result selecting the most important spreading codes, for example only those spreading codes of those other mobile terminals of which the power levels are larger than said threshold. These other mobile terminals will cause most of the interference, due to transmitting with higher power (for example as a result of being far away from the base station) compared to the rest of the other mobile terminals of which the power levels are smaller than said threshold, due to transmitting with lower power (for example as a result of being near the base station).

A second embodiment of the telecommunication system according to the invention as defined in claim 3 is advantageous in that said selector located between said generator and said transmitter, by selecting spreading codes and power information of a number of other mobile terminals to be sent to said at least one mobile terminal, reduces the computational complexity in the mobile terminal and reduces the amount of info to be broadcasted/sent. The selector makes an intelligent selection by for example using the power information (like power levels) of other mobile terminals, for example by comparing this power information with a threshold and in response to a comparison result selecting the most important spreading codes, for example only those spreading codes of those other mobile terminals of which the power levels are larger than said threshold. These other mobile terminals will cause most of the interference, due to transmitting with higher power (for example as a result of being far away from the base station) compared to the rest of the other mobile terminals of which the power levels are smaller than said threshold, due to transmitting with lower power (for example as a result of being near the base station).

A third embodiment of the telecommunication system according to the invention as defined in claim 4 is advantageous in that said information, further comprising direction information of other mobile terminals, allows said selecting in the mobile terminal as well as in the base station to be done even more intelligently. A base station comprising a smart antenna with antenna sectors can distinguish between mobile terminals in a first antenna sector and mobile terminals in a second antenna sector, which allows said selecting in the mobile terminal as well as in the base station to be done per antenna sector and/or in dependence of antenna sectors.

Embodiments of the base station according to the invention, of the mobile terminal according to the invention, of the method according to the invention and of both processor program products according to the invention correspond with the embodiments of the telecommunication system according to the invention.

These and other aspects of the invention will be apparent from and elucidated with reference to the embodiments(s) described hereinafter.

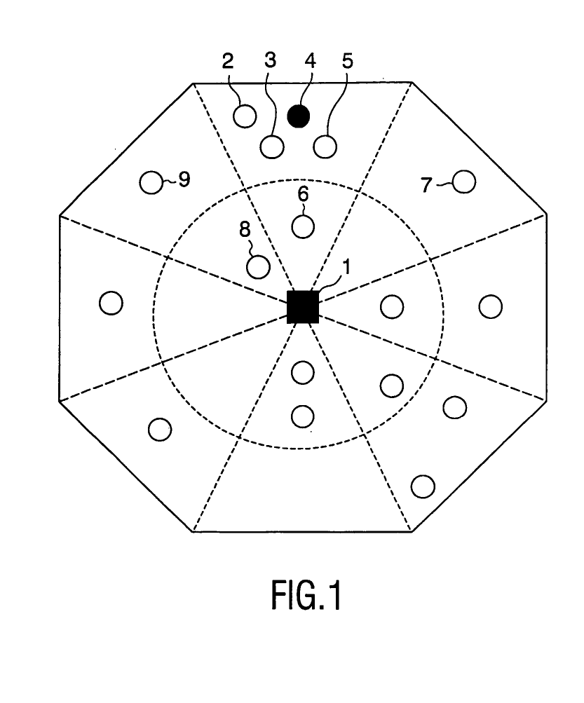

FIG. 1 illustrates in block diagram form a telecommunication system according to the invention comprising a base station according to the invention and mobile terminals according to the invention, and

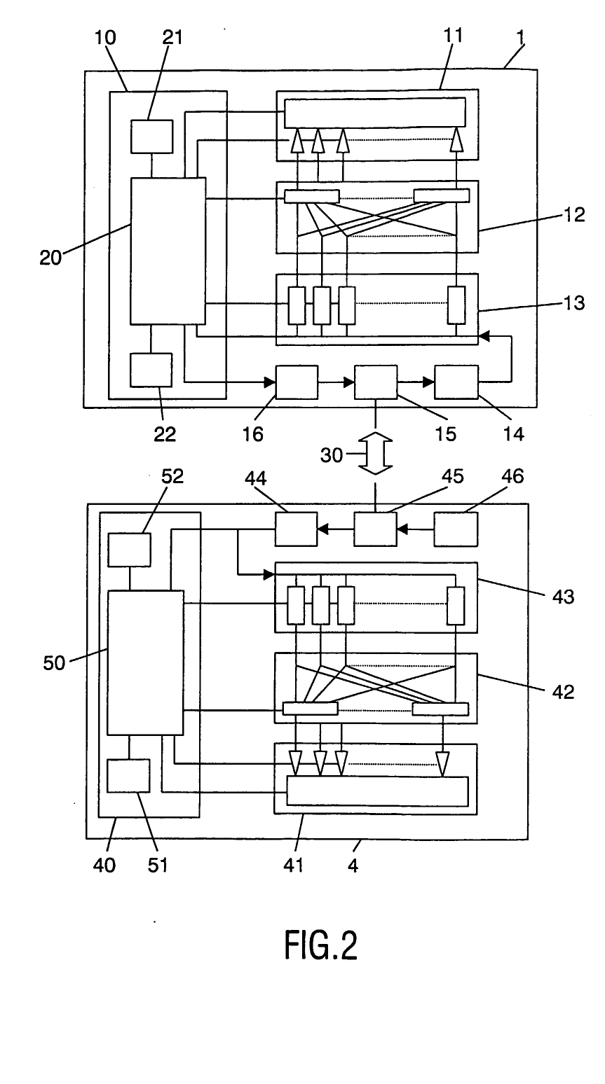

FIG. 2 illustrates a base station according to the invention and a mobile terminal according to the invention.

FIG. 1 illustrates a telecommunication system according to the invention comprising a base station 1 according to the invention and mobile terminals 2-9 according to the invention. Base station 1 comprises a smart antenna for dividing a cell into eight sectors: a first sector comprises terminals 2-6 of which terminals 2-5 are far away and transmit with higher power and of which terminal 6 is more close to base station 1 and transmits with lower power, a second sector comprises terminal 7 transmitting with higher power, etc., and an eighth sector comprises terminals 8,9 of which terminal 8 transmits with lower power and of which terminal 9 transmits with higher power.

FIG. 2 illustrates a base station 1 according to the invention and a mobile terminal 4 according to the invention.

Base station 1 comprises a controller 10 comprising a processor 20 coupled to a generator 21 and to a selector 22. An output of processor 20 is coupled to an input of a transmitter 16, of which an output is coupled to an input of a duplexer 15, of which an in/output is coupled to a smart antenna for mobile communication 30 and of which an output is coupled to an input of a receiver 14, of which an output is coupled to an input of a correlation system 13 and to an input of processor 20. Correlation system 13 comprises for example matched filters each coupled to processor 20 for despreading a received signal and providing samples per multi-user, with outputs of these matched filters being coupled to inputs of a reductor 12, which comprises for example combiners, usually one combiner per matched filter for combining samples from this matched filter with adapted samples of all other filters, for reducing Multiple Access Interference or MAI in the samples. Outputs of said combiners are coupled to inputs of a decision taker 11 comprising for example a comparator per input and a combination circuit coupled to all comparators for recovering the multi-user messages. Said comparators are each coupled to processor 20, and said combination circuit is coupled to processor 20. Either said reductor 12 is considered to be a multi-user detector, or reductor 12 together with correlation system 13 and/or decision taker 11 is considered to be a multi-user detector.

Mobile terminal 4 comprises a controller 40 comprising a processor 50 coupled to a memory 51 and to a selector 52. Mobile terminal 4 further comprises a transmitter 46, of which an output is coupled to an input of a duplexer 45, of which an in/output is coupled to an antenna for mobile communication 30 and of which an output is coupled to an input of a receiver 44, of which an output is coupled to an input of a correlation system 43 and to an input of processor 50. Correlation system 43 comprises for example matched filters each coupled to processor 50 for despreading a received signal and providing samples per multi-user, with outputs of these matched filters being coupled to inputs of a reductor 42, which comprises for example combiners, usually one combiner per matched filter for combining samples from this matched filter with adapted samples of all other filters, for reducing Multiple Access Interference or MAI in the samples. Outputs of said combiners are coupled to inputs of a decision taker 41 comprising for example a comparator per input and a combination circuit coupled to all comparators for recovering the message destined for this mobile terminal 4. Said comparators are each coupled to processor 50, and said combination circuit is coupled to processor 50. Either said reductor 42 is considered to be a multi-user detector, or reductor 42 together with correlation system 43 and/or decision taker 41 is considered to be a multi-user detector.

Prior art terminals do not comprise multi-user detectors, but comprise for example decentralized interference cancellers, which can be categorized in data aided detectors and non-data aided detectors. Data aided detectors adaptively learn the structure of the Multiple Access Interference or MAI, and non-data aided detectors treat MAI as a random process of which the statistics are to be estimated. As a result, the interference cancellation in the terminals is insufficient due to said adaptively learning (being a slow converging process) and/or said estimating (being an inaccurate process).

The mobile terminal 4 according to the invention comprises a multi-user detector in the form of for example reductor 42 possibly together with correlation system 41 and/or decision taker 43. Base station 1 according to the invention comprises transmitter 16 coupled to generator 21 via processor 20 for transmitting information comprising (at least parts of) spreading codes of other mobile terminals 2,3,5,6,7,8,9 to said mobile terminal 4, which comprises receiver 44 for receiving said information.

By providing said mobile terminal 4 with multi-user detector 41,42,43, which needs information comprising the spreading codes of the other mobile terminals 2,3,5,6,7,8,9, to be able to reduce Multiple Access Interference or MAI much more than general (decentralized) interference cancellers, the interference cancellation in the mobile terminal 4 is improved much. Due to said mobile terminal 4 now requiring said information, the base station 1, which already has got this information for its own purposes, is to be provided with the transmitter 16 for transmitting this information to the mobile terminal 4, which therefore is to be provided with the receiver 44 for receiving this information. The base station 1 thereby uses either a common control channel for broadcasting this information to several or all mobile terminals (in which case usually all spreading codes of all relevant terminals are sent to all relevant terminals), or a terminal specific control channel or a data channel for sending non-broadcastedly this information to one mobile terminal (in which case usually all spreading codes of all relevant terminals 2-9 are sent to all relevant terminals 2-9, but alternatively just the spreading codes of just the other terminals 2,3,5,6,7,8,9 are sent to terminal 4).

By providing said mobile terminal 4 with said selector 52 coupled to said receiver 44 via processor 50, a part of said information to be used by said multi-user detector 41,42,43 in said mobile terminal can now be selected, for reducing the computational complexity in mobile terminal 4. The selector 52 makes an intelligent selection by using the power information (like for example power levels) of the other mobile terminals 2,3,5,6,7,8,9 sent to mobile 4, for example by comparing these power levels with a threshold and in response to a comparison result selecting the most important spreading codes, for example only those spreading codes of those other mobile terminals 2,3,5,7,9 of which the power levels are larger than said threshold. These other mobile terminals 2,3,5,7,9 will cause most of the interference, due to transmitting with higher power (for example as a result of being far away from base station 1) compared to the rest of the other mobile terminals 6,8 of which the power levels are smaller than said threshold, due to transmitting with lower power (for example as a result of being near base station 1).

By providing base station 1 with said selector 22 located between said multi-user detector 11,12,13 via processor 20 and said transmitter 16, the spreading codes and power information of a number of other mobile terminals 2,3,5,7,9 to be sent to said mobile terminal 4 can be selected, for reducing the computational complexity in the mobile terminal 4 and for reducing the amount of info to be broadcasted/sent. The selector 22 makes an intelligent selection by for example using the power information (like for example power levels) of the other mobile terminals 2,3,5,6,7,8,9, for example by comparing these power levels with a threshold and in response to a comparison result selecting the most important spreading codes, for example only those spreading codes of those other mobile terminals 2,3,5,7,9 of which the power levels are larger than said threshold. These other mobile terminals 2,3,5,7,9 will cause most of the interference, due to transmitting with higher power (for example as a result of being far away from base station 1) compared to the rest of the other mobile terminals 6,8 of which the power levels are smaller than said threshold, due to transmitting with lower power (for example as a result of being near base station 1).

In case of base station 1 for example having a smart antenna, a cell is for example divided into eight sectors, and base station 1 can distinguish between mobile terminals in a first sector, in a second sector etc. and allocate to each mobile terminal direction information for example defining the sector in which said mobile terminal is situated. Then said selecting can be done even more intelligently, as follows.

In base station 1, selector 22 can select the spreading codes and power information of a number of other mobile terminals 2,3,5,6,7,8,9 to be sent to said mobile terminal 4, for reducing the computational complexity in the mobile terminal 4 and for reducing the amount of info to be broadcasted/sent. The selector 22 makes an intelligent selection by for example using the direction information of the other mobile terminals 2,3,5,6,7,8,9, for example by comparing this direction information with the direction information of mobile terminal 4 and in response to a comparison result selecting the most important spreading codes, for example only those spreading codes of those other mobile terminals 2,3,5,6 which are located in the same sector as mobile terminal 4. These other mobile terminals 2,3,5,6 will cause most of the interference, due to being located near mobile terminal 4.

In mobile terminal 4, selector 52 can select a part of said information to be used by said multi-user detector 41,42,43, for reducing the computational complexity in mobile terminal 4. The selector 52 makes an intelligent selection by using the direction information of the other mobile terminals 2,3,5,6,7,8,9, for example by comparing this direction information with the direction information of mobile terminal 4 and in response to a comparison result selecting the most important spreading codes, for example only those spreading codes of those other mobile terminals 2,3,5,6 which are located in the same sector as mobile terminal 4. These other mobile terminals 2,3,5,6 will cause most of the interference, due to being located near mobile terminal 4.

The invention is based upon an insight, inter alia, that multi-user detectors are better interference cancellers than general (decentralized) interference cancellers, and is based upon a basic idea, inter alia, that the information necessary for a multi-user detector in a mobile terminal can be transmitted from the base station to the mobile terminal. The invention solves the problem, inter alia, of providing a telecommunication system in which the interference cancellation in the mobile terminal as well as the capacity of the telecommunication system are improved.

When broadcasting codes, base station 1 can broadcast independently from said sectors, in which case at least the spreading codes and possibly either the power information and/or the direction information of generally all terminals in the same cell need to be sent to those terminals having a multi-user detector (generally all terminals). Base station 1 can also broadcast per sector, in which case at least the spreading codes and possibly the power information of generally all terminals in the same sector need to be sent to the terminals in this sector having a multi-user detector (generally all terminals in this sector). When sending codes/information non-broadcastedly, base station 1 can send independently from said sectors, in which case at least the spreading codes and possibly either the power information and/or the direction information of other terminals in the same cell need to be sent to a terminal having a multi-user detector. Base station 1 can also send per sector, in which case at least the spreading codes and possibly the power information of other terminals in the same sector need to be sent to a terminal in this sector having a multi-user detector.

The codes and information to be sent from base station 1 to mobile terminal 4 are generated by generator 21 and are transmitted via processor 20 and transmitter 16 and duplexer 15 in the form of a code signal to mobile terminal 4. In mobile terminal 4, said code signal arrives via duplexer 45 at receiver 44. Then, dependently upon the channel chosen and/or the receival, either said code signal is supplied directly to processor 50, or indirectly via multi-user detector 41,42,43, with correlation system 43 thereby firstly using for example just the already known spreading code of mobile terminal 4, and with reductor 42 reducing Multiple Access Interference or MAI in this code signal, and with decision taker 41 recovering the codes and information.

Generally, in case of said base station 1 transmitting spreading codes, power information and/or direction information of other mobile terminals to a mobile terminal, either the spreading code, power information and/or direction information of this mobile terminal is/are also sent to this mobile terminal, or this mobile terminal already has got this code and/or information. Said spreading codes may be official spreading codes or may alternatively be identification codes for (temporarily or unrestrictedly) identifying terminals. Said power information may also be energy information for indicating a power/energy level used for transmission, and said direction information may be angle information or definition information for defining sectors.

Each block shown or not shown, can be 100% hardware, 100% software or a mixture of both. Each block shown or not shown can be integrated with each other block shown and/or not shown. Especially generator 21, selector 22 and processor 20 in controller 10 could generally be integrated with each other, and selector 52 and processor 50 in controller 40 could generally be integrated with each other. Correlator systems 13,43 can be realized through their own processors/memories (parallelly) or through one processor/memory destined for performing all correlations (parallelly and/or serially) or through matched filters (parallelly and/or serially) cooperating with processors 20,50 or through software running via processors 20,50. Reductors 12,42 comprise combiners, usually one combiner per matched filter, for combining samples from this matched filter with adapted samples of all other filters, for reducing Multiple Access Interference or MAI in the samples. These combiners can be realized through their own processors/memories (parallelly) or through one processor/memory destined for performing all correlations (parallelly and/or serially) or through combiners (parallelly and/or serially) cooperating with processors 20,50 or through software running via processors 20,50, with said processors/memories and processors 20,50 taking care, per combiner, of said adapting of the samples of all other filters. Outputs of said combiners are coupled to inputs of decision taker 11,41 comprising for example a comparator per input and a combination circuit coupled to all comparators for recovering the multi-user messages in base station 1 and the message destined for mobile terminal 4 in mobile terminal 4. Said comparators are each coupled to processor 20,50 and said combination circuit is coupled to processor 20,50. Of course, due to mobile terminal 4 not needing to recover the multi-user messages from other terminals, but just needing multi-user detector 41,42,43 for interference cancellation inside mobile terminal 4, reductor 42 and decision taker 41 will be of a lower complexity compared to reductor 12 and decision taker 11 in base station 1. Receivers 14,44 will generally comprise a mixer and a demodulator, and may further comprise a switch, a buffer, and may form part of a transceiver, for example together with transmitters 16,46. Duplexers 15,45 could also be realized with switches, forks, hybrids etc.

1. Telecommunication system comprising a base station (1) and mobile terminals (2-9), with said base station (1) comprising a generator (21) for generating spreading codes and with at least one mobile terminal (4) comprising an interference canceller for reducing interference, characterized in that said base station (1) comprises a transmitter (16) coupled to said generator (21) for transmitting information comprising at least parts of other mobile terminals' spreading codes to said at least one mobile terminal (4), which comprises a receiver (44) for receiving said information, with said interference canceller comprising a multi-user detector (41,42,43) coupled to said receiver (44) for reducing interference by using said information.

2. Telecommunication system according to claim 1, characterized in that said information further comprises other mobile terminals' power information, with said at least one mobile terminal (4) comprising a selector (52) coupled to said receiver (4) for, in dependence of said power information, selecting at least parts of spreading codes of a number of other mobile terminals (2,3,5,6,7,8,9) to be used by said multi-user detector (41,42,43).

3. Telecommunication system according to claim 2, characterized in that said base station (1) comprises a selector (22) located between said generator (21) and said transmitter (16) for selecting at least parts of spreading codes and power information of a number of other mobile terminals (2,3,5,6,7,8,9) to be sent to said at least one mobile terminal (4).

4. Telecommunication system according to claim 2, characterized in that said information further comprises at least a part of an other mobile terminal's direction information.

5. Base station (1) for use in a telecommunication system comprising said base station (1) and mobile terminals (2-9), with said base station (1) comprising a generator (21) for generating spreading codes and with at least one mobile terminal (4) comprising an interference canceller for reducing interference, characterized in that said base station (1) comprises a transmitter (16) coupled to said generator (21) for transmitting information comprising at least parts of other mobile terminals' spreading codes to said at least one mobile terminal (4), which comprises a receiver (44) for receiving said information, with said interference canceller comprising a multi-user detector (41,42,43) coupled to said receiver (44) for reducing interference by using said information.

6. Base station (1) according to claim 5, characterized in that said base station (1) comprises a selector (22) located between said generator (21) and said transmitter (16) for selecting at least parts of spreading codes and power information of a number of other mobile terminals (2,3,5,6,7,8,9) to be sent to said at least one mobile terminal (4).

7. Mobile terminal (4) for use in a telecommunication system comprising a base station (1) and mobile terminals (2-9), with said base station (1) comprising a generator (21) for generating spreading codes and with said mobile terminal (4) comprising an interference canceller for reducing interference, characterized in that said mobile terminal (4) comprises a receiver (44) for receiving information comprising at least parts of other mobile terminals' spreading codes originating from said base station (1), with said interference canceller comprising a multi-user detector (41,42,43) coupled to said receiver (44) for reducing interference by using said information, and with said base station (1) comprising a transmitter (16) coupled to said generator (21) for transmitting said information to said mobile terminal (4).

8. Mobile terminal (4) according to claim 7, characterized in that said information further comprises other mobile terminals' power information, with said at least one mobile terminal (4) comprising a selector (52) coupled to said receiver (44) for, in dependence of said power information, selecting at least parts of spreading codes of a number of other mobile terminals (2,3,5,6,7,8,9) to be used by said multi-user detector (41,42,43).

9. Method for reducing interference in a mobile terminal, which method comprises the step of generating spreading codes in a base station, characterized in that said method comprises the steps of transmitting information comprising at least parts of other mobile terminals' spreading codes to a mobile terminal, of receiving said information in said mobile terminal, and of reducing interference by using said information in said mobile terminal.

10. Method according to claim 9, characterized in that the method comprises the step of at least either selecting a part of said information to be used in said mobile terminal, with said information further comprising other mobile terminals' power information, or selecting at least parts of spreading codes and power information of a number of other mobile terminals to be sent to said mobile terminal.

11. Processor program product to be run via a base station's processor for use in a base station of a telecommunication system comprising said base station and mobile terminals, with said processor program product comprising a generating function for generating spreading codes in said base station, and with at least one mobile terminal comprising an interference canceller for reducing interference, characterized in that said processor program product comprises a transmitting function for in response to said generating function transmitting information comprising at least parts of other mobile terminals' spreading codes to said at least one mobile terminal, which comprises a receiver for receiving said information, with said interference canceller comprising a multi-user detector coupled to said receiver for reducing interference by using said information.

12. Processor program product to be run via a mobile terminal's processor for use in a mobile terminal of a telecommunication system comprising a base station and mobile terminals, with said base station comprising a generator for generating spreading codes, and with said processor program product comprising an interference cancelling function for reducing interference, characterized in that said processor program product comprises a receiving function for receiving information comprising at least parts of other mobile terminals' spreading codes originating from said base station, with said interference cancelling function comprising a multi-user detection function for reducing interference by using said information in response to said receiving function, and with said base station comprising a transmitter coupled to said generator for transmitting said information to said mobile terminal.
